(19) United States
(12) Patent Application Publication
(10) Pub. No.: US 2025/0373743 A1
(43) Pub. Date: Dec. 4, 2025

(54) MEDIUM CONVEYING APPARATUS, IMAGE READING APPARATUS, MEDIUM CONVEYING METHOD, AND CONTROL PROGRAM

(71) Applicant: PFU LIMITED, Kahoku-shi (JP)

(72) Inventor: Masaaki Sakai, Kahoku-shi (JP)

(21) Appl. No.: 19/220,678

(22) Filed: May 28, 2025

(30) Foreign Application Priority Data
May 31, 2024 (JP) 2024-089187

(51) Int. Cl. H04N 1/00

(52) U.S. Cl. CPC H04N 1/00888; H04N 1/00236; H04N 2201/0036; H04N 2201/0094; H04N 2201/3276

(57) ABSTRACT

A medium conveying apparatus includes a conveyor to convey a medium, an interface connectable to an external device, and circuitry configured to change whether to allow communication with the external device via the interface or whether to allow supplying power to the external device via the interface based on a state of conveyance by the conveyor.

### CROSS-REFERENCE TO RELATED APPLICATION

This patent application is based on and claims priority pursuant to 35 U.S.C. § 119(a) to Japanese Patent Application No. 2024-089187, filed on May 31, 2024, in the Japan Patent Office, the entire disclosure of which is hereby incorporated by reference herein.

### BACKGROUND

The present disclosure relates to a medium conveying apparatus, an image reading apparatus, a medium conveying method, and a control program.

Enhancing user convenience is required in a medium conveying apparatus or an image reading apparatus such as a scanner that conveys a medium and captures an image on the medium. For this reason, a medium conveying apparatus or an image reading apparatus connectable to an external device as an operation device that receives an operation by a user or a storage device that stores information has been developed.

A facsimile multifunction peripheral that has at least two operating modes with different power consumption, stores user setting information that can be changed according to a user operation, and is connectable to an external apparatus has been proposed. The facsimile multifunction peripheral cuts off the power supply to an external interface that receives a request signal from the external device based on the operating mode and the user setting information.

### SUMMARY

The medium conveying apparatus according to one aspect of the present disclosure includes a conveyor to convey a medium, an interface connectable to an external device, and circuitry configured to change whether to allow communication with the external device via the interface or whether to allow supplying power to the external device via the interface based on a state of conveyance by the conveyor.

The image reading apparatus according to another aspect of the present disclosure includes an imager to image a medium to generate an input image, an output device to output the input image, an interface connectable to an external device, and circuitry configured to change whether to allow communication with the external device via the interface or whether to allow supplying power to the external device via the interface based on a state of imaging by the imager or a state of output by the output device.

The medium conveying method according to still another aspect of the present disclosure includes conveying a medium by a conveyor, and changing whether to allow communication with an external device via an interface connectable with the external device or whether to allow supplying power to the external device via the interface based on a state of conveyance by the conveyor.

The computer-readable, non-transitory medium according to still another aspect stores a control program. The control program causes a medium conveying apparatus including a conveyor to convey a medium and an interface connectable with an external device, to execute a process. The process includes changing whether to allow communication with the external device via the interface or whether to allow supplying power to the external device via the interface based on a state of conveyance by the conveyor.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an information processing system according to an embodiment of the present disclosure;

FIG. 2 is a diagram for explaining a conveying path inside an information processing apparatus according to an embodiment of the present disclosure;

FIG. 3 is a block diagram schematically illustrating a configuration of the information processing apparatus of FIG. 2;

FIG. 4 is a block diagram schematically illustrating a configuration of a memory and a processing circuit of the information processing apparatus of FIG. 2;

FIG. 5 is a flowchart of an example of a media reading process;

FIG. 6 is a continuation of the flowchart of FIG. 5; and

FIG. 7 is a block diagram schematically illustrating a configuration of another processing circuit of the information processing apparatus of FIG. 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A medium conveying apparatus and an image reading apparatus according to an aspect of the present disclosure are described below with reference to the drawings. However, the technical scope of the present disclosure is not limited to the embodiments described below but includes the scope of the appended claims and the equivalents thereof.

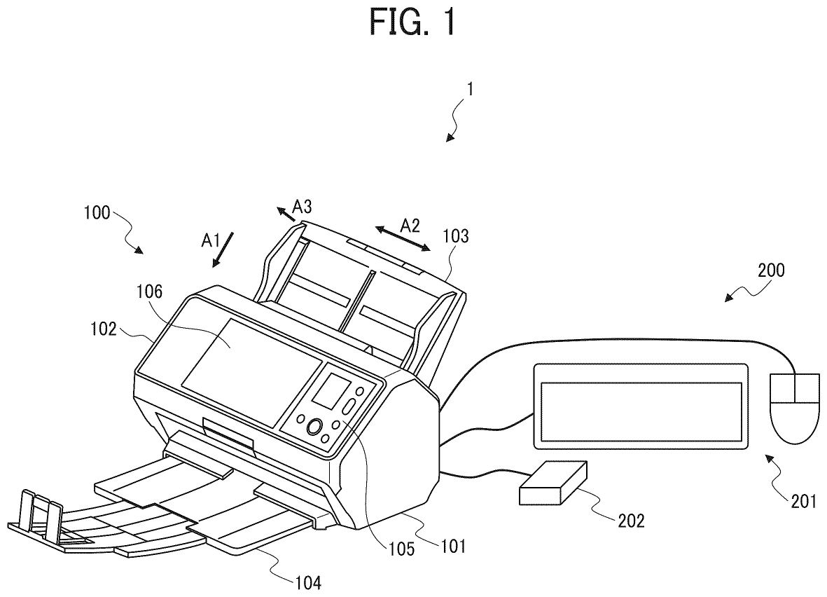

FIG. 1 is a perspective view of an information processing system 1 according to an embodiment.

The information processing system 1 includes an information processing apparatus 100 and an external device 200. The information processing apparatus 100 is an example of each of a medium conveying apparatus and an image reading apparatus. Examples of the information processing apparatus 100 include an image scanner. The information processing apparatus 100 conveys, images, and ejects media that are documents. Examples of the media include paper, cardboard, a plastic card, brochure paper, and a passport. Other examples of the information processing apparatus 100 include a facsimile machine, a copier, and a multifunction peripheral (MFP).

In FIG. 1, Arrow A1 indicates a direction in which media are conveyed (may be referred to as a “medium conveying direction A1” in the following description). Arrow A2 indicates the direction of the width of the information processing apparatus 100 (may be referred to as a “width direction A2” in the following description) perpendicular to the medium conveying direction A1. Arrow A3 indicates the height direction perpendicular to a medium conveying path. In the following description, the term “upstream” refers to upstream in the medium conveying direction A1, and the term “downstream” refers to downstream in the medium conveying direction A1. The width direction A2 is an example of a direction intersecting the medium conveying direction A1.

The information processing apparatus 100 includes a lower housing 101, an upper housing 102, a media tray 103, an ejection tray 104, an operation device 105, and a display device 106.

The upper housing 102 is located at a position covering the upper face of the information processing apparatus 100 and is engaged with the lower housing 101 via a hinge such that the upper housing 102 can be opened and closed to, for example, remove a jammed medium or clean the inside of the information processing apparatus 100.

The media tray 103 is engaged with the lower housing 101. Media to be fed and conveyed are placed on the media tray 103. The ejection tray 104 is engaged with the lower housing 101 and stacks ejected media. The ejection tray 104 may be engaged with the upper housing 102 with a hinge or the like.

The operation device 105 includes an input device such as keys and an interface circuit that acquires signals from the input device. The operation device 105 receives an input operation performed by a user and outputs an operation signal corresponding to the input operation. The display device 106 includes a display and an interface circuit that outputs image data to the display, and displays image data on the display. Examples of the display include a liquid crystal display and an organic electroluminescent (EL) display. The display device 106 may be a display with a touch panel function. In this case, the operation device 105 may include an interface circuit that receives signals from the touch panel.

The external device 200 is a device connectable to the information processing apparatus 100. The external device 200 includes an operation device 201 and a storage device 202. The operation device 201 is a device that controls the information processing apparatus 100. The operation device 201 is a human interface device (HID) such as a keyboard or a mouse and receives an operation performed by a user. The storage device 202 is a device that acquires information from the information processing apparatus 100. The storage device 202 is a memory such as a universal serial bus (USB) memory, a hard disk drive (HDD), or a solid-state drive (SSD), and stores any information such as an image or text.

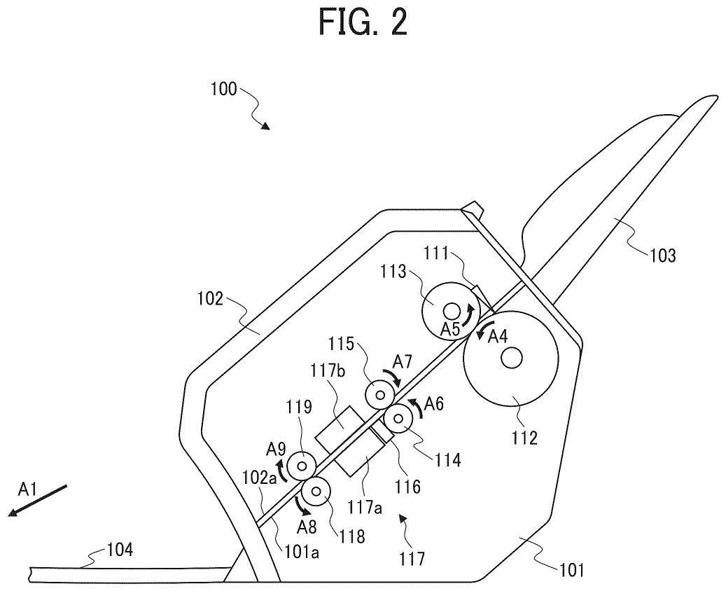

FIG. 2 is a diagram for explaining a conveying path inside the information processing apparatus 100.

The conveying path inside the information processing apparatus 100 includes a first media sensor 111, a feed roller 112, a separation roller 113, a first conveyance roller 114, a second conveyance roller 115, a second media sensor 116, an imaging device 117, and a first ejection roller 118, and a second ejection roller 119. The feed roller 112, the separation roller 113, the first conveyance roller 114, the second conveyance roller 115, the first ejection roller 118, and the second ejection roller 119 are examples of a conveyor that conveys to convey a medium. The number of each of the above rollers is not limited to one, but may be two or more. When one or more of the above rollers are formed of multiple rollers, the multiple rollers are located at intervals in the width direction A2.

The upper face of the lower housing 101 forms a lower guide 101a for the medium conveying path. The lower face of the upper housing 102 forms an upper guide 102a for the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104. Since the medium conveying path is a straight path, the information processing apparatus 100 is compact.

The first media sensor 111 is located upstream from the feed roller 112 and the separation roller 113. The first media sensor 111 includes a contact detection sensor and detects whether a medium is placed on the media tray 103. The first media sensor 111 generates a first media signal of which the signal value changes depending on whether a medium is placed on the media tray 103 and outputs the generated first media signal. The first media sensor 111 is not limited to a contact detection sensor. The first media sensor 111 may be any other sensor that can detect the presence of a medium. Examples of any other sensor include an optical detection sensor.

The feed roller 112 is located in the lower housing 101 and feeds the media from to the top from the media tray 103. The separation roller 113 is a so-called brake roller or retard roller. The separation roller 113 is located in the upper housing 102 and faces the feed roller 112. The feed roller 112 and the separation roller 113 function as a separator that separates media. A separation pad may be used instead of the separation roller 113.

The first conveyance roller 114 and the second conveyance roller 115 are located downstream from the feed roller 112 and the separation roller 113 and face each other. The first conveyance roller 114 and the second conveyance roller 115 convey the medium fed by the feed roller 112 and the separation roller 113 to the imaging device 117. One of the first conveyance roller 114 and the second conveyance roller 115 may be a driven roller that rotates following the other roller.

The second media sensor 116 detects a medium conveyed to the position of the second media sensor 116. The second media sensor 116 is located downstream from the first conveyance roller 114 and the second conveyance roller 115 and upstream from the imaging device 117. Alternatively, the second media sensor 116 may be located downstream from the feed roller 112 and the separation roller 113 and upstream from the first conveyance roller 114 and the second conveyance roller 115. The second media sensor 116 includes a light emitter, a light receiver, and a light guide. The light emitter and the light receiver are located on one side of the medium conveying path. The light guide faces the light emitter and the light receiver across the medium conveying path. The light emitter is, for example, a light-emitting diode (LED) and emits light toward the medium conveying path. The light receiver is, for example, a photodiode and detects (receives) the light that is emitted by the light emitter and guided by the light guide. When a medium is present at a position facing at least one of the light emitter and the light receiver, the light emitted from the light emitter is blocked by the medium, and therefore the light receiver does not detect the light emitted from the light emitter. Based on the intensity of the light received by the light receiver, the second media sensor 116 generates and outputs a second media signal of which the signal value changes between when a medium is present at the position of the second media sensor 116 and when a medium is absent at the position of the second media sensor 116.

The second media sensor 116 may include a reflector such as a mirror instead of the light guide. The light emitter and the light receiver in the second media sensor 116 may be located facing each other with the medium conveying path therebetween. Further, the second media sensor 116 may detect a medium with, for example, a contact sensor that allows a certain current to flow when a medium is in contact with the contact sensor or when no medium is in contact with the contact sensor.

The imaging device 117 is an example of an imager. The imaging device 117 is located downstream from the first conveyance roller 114 and the second conveyance roller 115 and upstream from the first ejection roller 118 and the second ejection roller 119. The imaging device 117 includes a first imaging device 117a and a second imaging device 117b. The first imaging device 117a and the second imaging device 117b are located near the medium conveying path and face each other with the medium conveying path therebetween.

The first imaging device 117a includes an imaging sensor based on a unity-magnification optical system type contact image sensor (CIS) including complementary metal oxide semiconductor-(CMOS-) based imaging elements linearly arranged in a main scanning direction. The first imaging device 117a further includes a lens that forms an image on the imaging elements and an analog-to-digital (A/D) converter that amplifies electrical signals output from the imaging elements and performs A/D conversion. The first imaging device 117a generates an input image by imaging the front side of a conveyed medium and outputs the generated input image.

The second imaging device 117b includes an imaging sensor based on a unity-magnification optical system type CIS including CMOS-based imaging elements linearly arranged in the main scanning direction. The second imaging device 117b further includes a lens that forms an image on the imaging elements and an A/D converter that amplifies electrical signals output from the imaging elements and performs A/D conversion. The second imaging device 117b generates an input image by imaging the back side of a conveyed medium and outputs the generated input image.

The information processing apparatus 100 may include either the first imaging device 117a or the second imaging device 117b to read only one side of the medium. Instead of the line sensor based on a unity-magnification optical system type CIS including CMOS-based imaging elements, a line sensor based on a unity-magnification optical system type CIS including charge-coupled device-(CCD-) based imaging elements may be used. A reduction optical system type line sensor including CMOS-based or CCD-based imaging elements may be used.

The first ejection roller 118 and the second ejection roller 119 are located downstream from the first conveyance roller 114 and the second conveyance roller 115 and face each other. The first ejection roller 118 and the second ejection roller 119 convey the medium that is conveyed by the first conveyance roller 114 and the second conveyance roller 115 further downstream and eject the conveyed medium to the ejection tray 104. One of the first ejection roller 118 and the second ejection roller 119 may be a driven roller that rotates following the other roller.

The media placed on the media tray 103 are conveyed between the lower guide 101a and the upper guide 102b in the medium conveying direction A1 as the feed roller 112 rotates in the direction indicated by Arrow A4 in FIG. 2. The separation roller 113 rotates or stops in a direction indicated by Arrow A5, that is, in the direction opposite to the media feeding direction when conveying the medium. Due to the action of the feed roller 112 and the separation roller 113, when multiple media is placed on the media tray 103, only a medium in contact with the feed roller 112 among the media placed on the media tray 103 is separated.

This prevents the feeding of a medium other than the separated medium. In other words, the multi-feed is prevented.

The medium is fed between the first conveyance roller 114 and the second conveyance roller 115 while being guided by the lower guide 101a and the upper guide 102b. The medium is fed between the first imaging device 117a and the second imaging device 117b as the first conveyance roller 114 and the second conveyance roller 115 rotate in the directions indicated by Arrows A6 and A7 in FIG. 2, respectively. The medium read by the imaging device 117 is ejected onto the ejection tray 104 as the first ejection roller 118 and the second ejection roller 119 rotate in the directions indicated by Arrows A8 and A9 in FIG. 2, respectively.

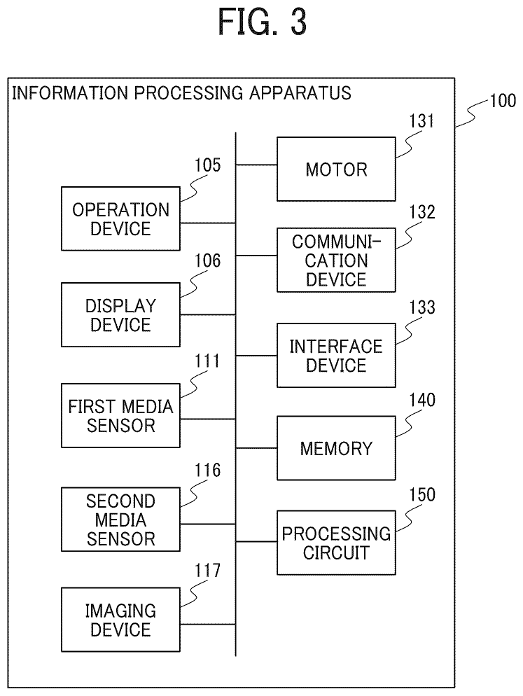

FIG. 3 is a block diagram schematically illustrating a configuration of the information processing apparatus 100.

The information processing apparatus 100 further includes a motor 131, a communication device 132, an interface device 133, a memory 140, and a processing circuit 150, in addition to the configuration described above.

The motor 131 includes one or a plurality of motors. The motor 131 rotates the feed roller 112, the separation roller 113, the first conveyance roller 114, the second conveyance roller 115, the first ejection roller 118, and/or the second ejection roller 119 according to a control signal from the processing circuit 150 to convey a medium.

The communication device 132 is an example of an output device that outputs the input image. The communication device 132 includes an antenna that transmits and receives wireless signals, and a wireless communication interface circuit for transmitting and receiving signals to and from a control apparatus that controls the information processing apparatus 100 through a wireless communication line according to a predetermined communication protocol. Examples of the predetermined communication protocol include a wireless local area network (LAN) communication protocol. The communication device 132 is communicable with the control apparatus such as a personal computer or a mobile information terminal and is communicably connected to the control apparatus to transmit and receive the input image and various information. The communication device 132 may include a wired communication interface circuit according to a communication protocol such as the Transmission Control Protocol/Internet Protocol (TCP/IP) and may be communicably connected to the control apparatus. The communication device 132 may include an interface circuit compliant with a serial bus standard such as USB or PS/2, or an interface circuit according to a wireless communication standard such as Bluetooth® or radiofrequency identification (RFID) and may be communicably connected to the control apparatus.

The interface device 133 is an example of an interface. The interface device 133 includes an interface circuit compliant with a serial bus standard such as USB of PS/2. The interface device 133 is connectable to the external device 200 and is electrically connected to the external device 200 to transmit and receive the input image and various information. The interface device 133 is communicable with multiple types of external devices 200 including the operation device 201 and the storage device 202. When the external device 200 is connected to the interface device 133, the interface device 133 detects the connected external device 200, acquires identification information from the external device 200, and identifies the type of the external device 200 based on the acquired identification information. Examples of the type of the external device 200 include an operation device and a storage device. The identification information is information based on which the external device 200 is identified. For example, when the external device 200 is compliant with the USB standard, the identification information is a vendor identifier (ID), a product ID, a serial number, and the like assigned to the external device 200. The interface device 133 outputs a connected device signal indicating the external device 200 connected to the interface device 133 according to an instruction from the processing circuit 150. Further, the interface device 133 can supply power to each external device 200, and supplies power to each external device 200 or stops power supply according to an instruction from the processing circuit 150. The interface device 133 may include an antenna for transmitting and receiving wireless signals, and an interface circuit according to a wireless communication standard such as Bluetooth® or RFID or an interface circuit for dedicated wireless communication, and may be connected to the external device 200.

The memory 140 includes memories such as a random-access memory (RAM) and a read-only memory (ROM), a fixed disk device such as a hard disk, or a portable memory such as a flexible disk or an optical disc. The memory 140 stores computer programs, databases, tables, and the like used for various processes performed by the information processing apparatus 100. The computer programs may be installed in the memory 140 from a computer-readable portable recording medium using, for example, a known setup program. Examples of the portable recording medium include a compact disc read-only memory (CD-ROM) and a digital versatile disc read-only memory (DVD-ROM). The computer programs may be distributed from, for example, a server and installed in the memory 140.

The processing circuit 150 operates according to a program prestored in the memory 140. Examples of the processing circuit 150 include a central processing unit (CPU). Alternatively, a digital signal processor (DSP), a large-scale integration (LSI), an application-specific integrated circuit (ASIC), or a field-programmable gate array (FPGA) may be used as the processing circuit 150.

The processing circuit 150 is connected to the operation device 105, the display device 106, the first media sensor 111, the second media sensor 116, the imaging device 117, the motor 131, the communication device 132, the interface device 133, and the memory 140, and controls these components. The processing circuit 150 controls the driving of the motor 131 and the imaging by the imaging device 117 according to signals received from the sensors described above. The processing circuit 150 acquires the input image from the imaging device 117 and transmits the input image to the control apparatus via the communication device 132. The processing circuit 150 transmits and receives signals to and from the operation device 201 or the storage device 202 via the interface device 133, controls the information processing apparatus 100 in accordance with the signals received from the operation device 201, and transmits the input image to the storage device 202.

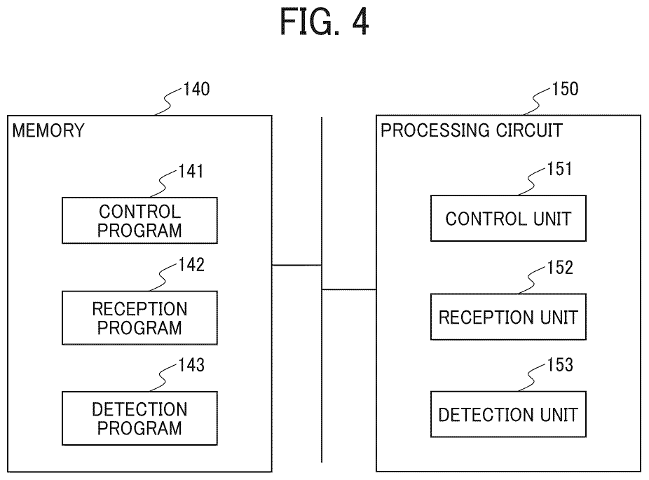

FIG. 4 is a block diagram schematically illustrating a configuration of the memory 140 and the processing circuit 150.

As illustrated in FIG. 4, the memory 140 stores a control program 141, a reception program 142, and a detection program 143. These programs are functional modules implemented by software operating on a processor. The processing circuit 150 reads the programs from the memory 140 and operates according to the read programs. Thus, the processing circuit 150 functions as a control unit 151, a reception unit 152, and a detection unit 153.

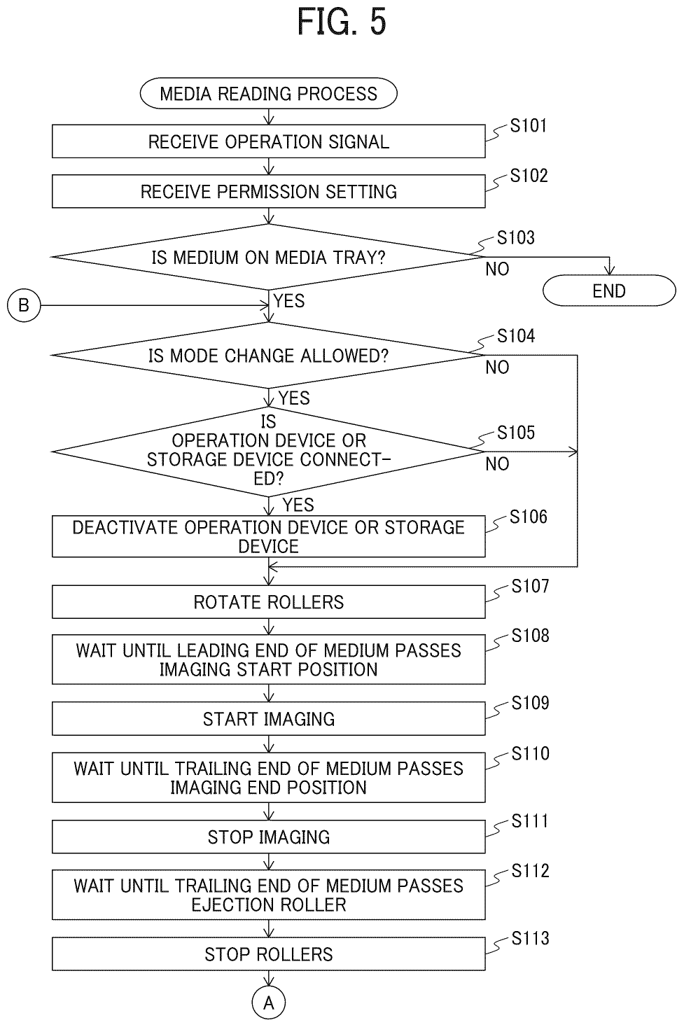

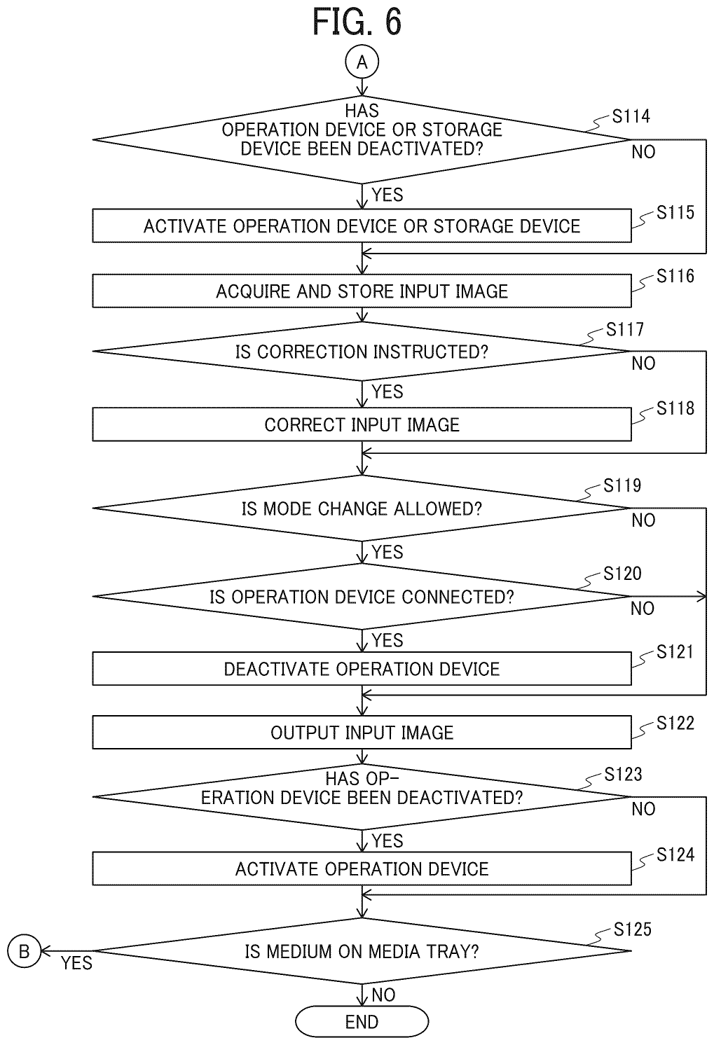

FIG. 5 is a flowchart of an example of a media reading process performed by the information processing apparatus 100. FIG. 6 is a continuation of the flowchart of FIG. 5.

An example of a media reading process performed by the information processing apparatus 100 is described below with reference to the flowchart of FIG. 5 and FIG. 6. The process described below is executed mainly by the processing circuit 150 in cooperation with the components of the information processing apparatus 100 based on the programs prestored in the memory 140.

The control unit 151 periodically receives the connected device signal from the interface device 133 after the information processing apparatus 100 starts up. When a new external device 200 is connected to the interface device 133, the control unit 151 transmits a supply instruction signal instructing to supply power to the newly connected external device 200 to the interface device 133 when a medium is not being conveyed. In response to receiving the supply instruction signal, the interface device 133 supplies power to the designated external device 200.

In step S101, the control unit 151 waits until the control unit 151 receives an operation signal instructing the reading of media from the operation device 105, the communication device 132, or the interface device 133. The operation signal is output when the user inputs an instruction to read media using the operation device 105, the control apparatus, or the operation device 201.

In step S102, the reception unit 152 receives a permission setting for changing whether to allow communication with the external device 200 via the interface device 133 or whether to allow the supply of power to the external device 200 via the interface device 133. The permission setting is configured according to a user's operation. In the following description, changing whether to allow communication with the external device 200 via the interface device 133 or whether to allow the supply of power to the external device 200 via the interface device 133 may be referred to as a “mode change.” The reception unit 152 acquires, for example, a profile included in the operation signal. The profile includes a setting regarding imaging processing, image processing, or conveyance processing. The profile is set by a user according to, for example, the usage of an image to be generated or the type of medium to be imaged. The setting regarding imaging processing, image processing, or conveyance processing includes a setting of whether to permit the mode change. When the profile specifies that the mode change is permitted, the reception unit 152 receives the permission setting of the mode change. The profile may be designated by the user before inputting the instruction to read a medium and stored in the memory 140, instead of being designated along with the instruction to read the medium. In such a case, the reception unit 152 acquires the profile by reading the profile from the memory 140.

In step S103, the control unit 151 acquires the first media signal from the first media sensor 111 and determines whether a medium is placed on the media tray 103 based on the acquired first media signal. When no medium is present on the media tray 103, the control unit 151 ends the series of steps.

By contrast, when a medium is placed on the media tray 103, the control unit 151 determines whether the mode change is allowed in step S104. The control unit 151 determines that the mode change is allowed when the reception unit 152 has received the permission setting of the mode change, and determines that the mode change is not allowed when the reception unit 152 has not received the permission setting of the mode change.

When the mode change is not allowed, the control unit 151 does not perform any processing. The process then proceeds to step S107.

By contrast, when the mode change is allowed, the detection unit 153 determines whether the operation device 201 or the storage device 202 is connected to the interface device 133 in step S105. The detection unit 153 receives a connected device signal from the interface device 133 and determines whether the operation device 201 or the storage device 202 is connected to the interface device 133 based on the received connected device signal. Thus, the detection unit 153 detects the connection of the external device 200 to the interface device 133. When neither the operation device 201 nor the storage device 202 is connected to the interface device 133, the control unit 151 does not perform any processing. The process then proceeds to step S107.

By contrast, when the operation device 201 or the storage device 202 is connected to the interface device 133, the control unit 151 performs the deactivation of the operation device 201 or the storage device 202 connected to the interface device 133 in step S106. For example, the control unit 151 performs the deactivation of the operation device 201 or the storage device 202 by prohibiting the processing circuit 150 from communicating with the operation device 201 or the storage device 202 via the interface device 133. Alternatively, the control unit 151 performs the deactivation of the operation device 201 or the storage device 202 by stopping the power supply to the operation device 201 or the storage device 202 via the interface device 133. In this case, the control unit 151 transmits a stop instruction signal instructing to stop the supply of power to the operation device 201 or the storage device 202 to the interface device 133. In response to receiving the stop instruction signal, the interface device 133 stops the supply of power to the designated operation device 201 or storage device 202. As a result, the processing circuit 150 is subsequently no longer able to use the operation device 201 or the storage device 202 connected to the interface device 133.

In step S107, the control unit 151 drives the motor 131 to rotate the feed roller 112, the separation roller 113, the first conveyance roller 114, the second conveyance roller 115, the first ejection roller 118, and/or the second ejection roller 119 to feed and convey a medium.

In step S108, the control unit 151 waits until the leading end of the media passes an imaging start position. The control unit 151 periodically acquires the second media signal from the second media sensor 116 and determines that the leading end of the medium has passed the position of the second media sensor 116 when the signal value of the second media signal changes from a value indicating the absence of a medium to a value indicating the presence of a medium. The control unit 151 determines that the leading end of the medium has passed the imaging start position when the leading end of the medium has passed the position of the second media sensor 116.

In step S109, the control unit 151 controls the imaging device 117 to start imaging the medium.

In step S110, the control unit 151 waits until the trailing end of the media passes an imaging end position. The control unit 151 determines that the trailing end of the medium has passed the position of the second media sensor 116 when the signal value of the second media signal changes from a value indicating the presence of a medium to a value indicating the absence of a medium. The control unit 151 determines that the trailing end of the medium has passed the imaging end position when a first predetermined time period has elapsed since the trailing end of the medium has passed the position of the second media sensor 116. The first predetermined time period is set to a time taken for a medium to move from the second media sensor 116 to the imaging end position.

In step S111, the control unit 151 controls the imaging device 117 to stop imaging the medium.

In step S112, the control unit 151 waits until the trailing end of the medium passes the position of the first ejection roller 118 and the second ejection roller 119. The control unit 151 determines that the trailing end of the medium has passed the first ejection roller 118 and the second ejection roller 119 when a second predetermined time period has elapsed since the trailing end of the medium has passed the position of the second media sensor 116. The second predetermined time period is set to a time taken for a medium to move from the position of the second media sensor 116 to the downstream end of the nip between the first ejection roller 118 and the second ejection roller 119.

In step S113, the control unit 151 controls the motor 131 to stop the feed roller 112, the separation roller 113, the first conveyance roller 114, the second conveyance roller 115, the first ejection roller 118, and/or the second ejection roller 119.

In step S114, the control unit 151 determines whether the deactivation of the operation device 201 or the storage device 202 connected to the interface device 133 has been performed in step S106. When the deactivation of the operation device 201 or the storage device 202 has not been performed, the control unit 151 does not perform any processing. The process then proceeds to step S116.

By contrast, when the deactivation of the operation device 201 or the storage device 202 has been performed, the control unit 151 performs activation of the operation device 201 or the storage device 202 connected to the interface device 133 in step S115. When the communication with the operation device 201 or the storage device 202 has been prohibited, the control unit 151 performs activation of the operation device 201 or the storage device 202 by permitting the communication with the operation device 201 or the storage device 202. When the supply of power to the operation device 201 or the storage device 202 has been stopped, the control unit 151 performs the activation of the operation device 201 or the storage device 202 by supplying power to the operation device 201 or the storage device 202. In this case, the control unit 151 transmits a supply instruction signal instructing to supply power to the operation device 201 or the storage device 202 to the interface device 133. In response to receiving the supply instruction signal, the interface device 133 supplies power to the designated operation device 201 or storage device 202. As a result, the processing circuit 150 is subsequently able to use the operation device 201 or the storage device 202 connected to the interface device 133.

As described above, the control unit 151 prohibits communication with the external device 200 via the interface device 133 or stops supplying power to the external device 200 via the interface device 133 while the conveyor is conveying a medium. In other words, the control unit 151 changes whether to allow communication with the external device 200 via the interface device 133 or whether to allow supplying power to the external device 200 via the interface device 133 based on the state of conveyance by the conveyor. By not performing unnecessary communication or power supply while a medium is being conveyed, the information processing apparatus 100 reduces an increase in the processing load and/or power consumption in the medium reading process and prevents the occurrence of a user's erroneous operation.

Further, the control unit 151 prohibits communication with the external device 200 via the interface device 133 or stops supplying power to the external device 200 via the interface device 133 during imaging by the imaging device 177. In other words, the control unit 151 changes whether to allow communication with the external device 200 via the interface device 133 or whether to allow supplying power to the external device 200 via the interface device 133 based on the state of imaging by the imaging device 117. By not performing unnecessary communication or power supply while a medium is being imaged, the information processing apparatus 100 reduces an increase in the processing load and/or power consumption in the medium reading process and prevents the occurrence of a user's erroneous operation.

Specifically, the control unit 151 prohibits communication with the operation device 201 or the storage device 202 or stops supplying power to the operation device 201 or the storage device 202 while the conveyor is conveying a medium or while the imaging device 117 is imaging a medium. Thus, the information processing apparatus 100 does not communicate with an unnecessary device or does not supply power to an unnecessary device while the conveyor is conveying a medium or while the imaging device 117 is imaging a medium. As a result, the information processing apparatus 100 reduces an increase in the processing load and/or power consumption in the medium reading process and prevents the occurrence of a user's erroneous operation.

Further, the control unit 151 prohibits communication with the external device 200 via the interface device 133 or stops supplying power to the external device 200 via the interface device 133 on the condition that the external device 200 is connected to the interface device 133. In other words, the control unit 151 changes whether to allow communication with the external device 200 via the interface device 133 or whether to allow supplying power to the external device 200 via the interface device 133 based on the state of connection of the external device 200 to the interface device 133. By not performing the mode change when the external device 200 is not connected to the interface device 133, the information processing apparatus 100 prevents the processing load and the processing time in the medium reading process from increasing.

Further, the reception unit 152 receives the permission setting for the mode change according to a user's operation. Thus, the user can set whether to allow the mode change based on the usage of the information processing apparatus 100, the type of medium to be imaged, or the like. As a result, the information processing apparatus 100 enhances the user convenience.

In step S116, the control unit 151 acquires an input image from the imaging device 117 and stores the input image in the memory 140, or in the storage device 202 via the interface device 133. For example, when the storage device 202 is connected to the interface device 133, the control unit 151 stores the input image in the storage device 202, and when the storage device 202 is not connected to the interface device 133, the control unit 151 stores the input image in the memory 140. Alternatively, the control unit 151 may store the input image in one of the memory 140 or the storage device 202, whichever is designated in advance by a user in the profile.

Subsequently, the control unit 151 displays an inquiry window that displays the input image and inquires of the user whether to correct the input image and the content of the correction on the display device 106, or transmits the inquiry window to the control apparatus via the communication device 132 and controls the control apparatus to display the inquiry window. The control unit 151 waits until the user inputs an instruction regarding correction using the operation device 105, the control apparatus, or the operation device 201 and then a correction instruction signal is received from the operation device 105, the communication device 132, or the interface device 133. The correction instruction signal indicates whether correction is to be performed on the input image and the content of the correction. In step S117, the control unit 151 determines whether the user has instructed correction of the input image. The control unit 151 determines whether the user has instructed the correction of the input image based on whether the correction instruction signal indicates that the correction is to be performed on the input image. When the user has not instructed the correction of the input image, the control unit 151 does not perform any processing. The process then proceeds to step S119.

By contrast, when the user has instructed the correction of the input image, the control unit 151 corrects the input image based on the content of the correction indicated by the correction instruction signal in step S118. The control unit 151 performs correction such as cropping, gamma correction, and filtering on the input image using a known image processing technology.

In step S119, the control unit 151 determines whether the mode change is allowed in the same or substantially the same manner as step S104. When the mode change is not allowed, the control unit 151 does not perform any processing. The process then proceeds to step S122.

By contrast, when the mode change is allowed, in step S120, the detection unit 153 determines whether the operation device 201 is connected to the interface device 133 in the same or substantially the same manner as step S105. When the operation device 201 is not connected to the interface device 133, the control unit 151 does not perform any processing. The process then proceeds to step S122.

By contrast, when the operation device 201 is connected to the interface device 133, in step S121, the control unit 151 performs the deactivation of the operation device 201 connected to the interface device 133 in the same or substantially the same manner as step S106. As a result, the processing circuit 150 is subsequently no longer able to use the operation device 201 connected to the interface device 133.

In step S122, the control unit 151 outputs the input image by transmitting the input image to the control apparatus via the communication device 132 or storing the input image in the storage device 202 via the interface device 133. For example, when the storage device 202 is connected to the interface device 133, the control unit 151 stores the input image in the storage device 202, and when the storage device 202 is not connected to the interface device 133, the control unit 151 transmits the input image to the control apparatus via the communication device 132. Alternatively, the control unit 151 may output the input image to one of the control apparatus or the storage device 202, whichever is designated in advance by a user in the profile.

In step S123, the control unit 151 determines whether the deactivation of the operation device 201 connected to the interface device 133 has been performed in step S121. When the deactivation of the operation device 201 has not been performed, the control unit 151 does not perform any processing. The process then proceeds to step S125.

By contrast, when the deactivation of the operation device 201 has been performed, in step S124, the control unit 151 performs activation of the operation device 201 connected to the interface device 133 in the same or substantially the same manner as step S115. As a result, the processing circuit 150 is subsequently able to use the operation device 201 connected to the interface device 133.

As described above, the control unit 151 prohibits communication with the external device 200 via the interface device 133 or stops supplying power to the external device 200 via the interface device 133 while the communication device 132 is outputting an input image. In other words, the control unit 151 changes whether to allow communication with the external device 200 via the interface device 133 or whether to allow supplying power to the external device 200 via the interface device 133 based on the state of output by the communication device 132. By not performing unnecessary communication or power supply while information is being output, the information processing apparatus 100 reduces an increase in the processing load and/or power consumption in the medium reading process and prevents the occurrence of a user's erroneous operation.

Further, the control unit 151 prohibits communication with the operation device 201 or stops supplying power to the operation device 201 while the communication device 132 is outputting an input image. Thus, the information processing apparatus 100 does not communicate with an unnecessary device or does not supply power to an unnecessary device while the communication device 132 is outputting an input image. As a result, the information processing apparatus 100 reduces an increase in the processing load and/or power consumption in the medium reading process and prevents the occurrence of a user's erroneous operation.

On the other hand, the control unit 151 does not prohibit communication with the storage device 202 or does not stop supplying power to the storage device 202 while the communication device 132 is outputting an input image. In other words, the control unit 151 changes whether to allow communication with the external device 200 via the interface device 133 or whether to allow supplying power to the external device 200 via the interface device 133 based on the type of the external device 200 connected to the interface device 133. As a result, the information processing apparatus 100 can flexibly change whether to allow communication or whether to allow supplying power based on the type of the external device 200, and further reduces an increase in the processing load and/or power consumption in the medium reading process and further prevents the occurrence of a user's erroneous operation.

In step S125, the control unit 151 determines whether a medium remains on the media tray 103 based on the first media signal received from the first media sensor 111. When a medium remains on the media tray 103, the control unit 151 returns the process to step S104 and repeats steps S104 to S125. By contrast, when no medium remains on the media tray 103, the control unit 151 ends the series of steps.

The information processing apparatus 100 may not support either the operation device 201 or the storage device 202. The processing of steps S104 to S106 may be performed between the processing of step S108 and the processing of step S109, and the processing of steps S114 to S115 may be performed between the processing of step S111 and the processing of step S112. The processing of step S117 to S118 may be omitted.

The control unit 151 may stop the conveyance of media when the conveyance of all the media collectively placed on the media tray 103 is completed, rather than stopping the conveyance of media each time the conveyance of each medium is completed. In this case, the control unit 151 may deactivate the operation device 201 and/or the storage device 202 until the conveyance of all the media is completed.

The control unit 151 may correct input images each of which is obtained by imaging each medium after the conveyance of all the media is completed. In this case, the control unit 151 may deactivate the operation device 201 until the conveyance of all the media is completed.

The control unit 151 may output input images each of which is obtained by imaging each medium after the conveyance of all the media is completed. In this case, the control unit 151 may deactivate the storage device 202 until the conveyance of all the media is completed.

The control unit 151 may activate the operation device 201 when receiving an instruction from a user using the operation device 201 and deactivate the operation device 201 at other times. The control unit 151 may activate the storage device 202 when writing or reading information to or from the storage device 202 and deactivate the storage device 202 at other times.

As described above in detail, the information processing apparatus 100 changes whether to allow communication with the external device 200 via the interface device 133 or whether to allow supplying power to the external device 200 via the interface device 133 based on the state of conveyance of a medium, the state of imaging of a medium, or the state of output of an input image. This allows the information processing apparatus 100 to appropriately control communication with the external device 200 via the interface device 133 or power supply to the external device 200 via the interface device 133.

Specifically, the information processing apparatus 100 activates the external device 200 when the external device 200 needs to be used and deactivates the external device 200 when the external device 200 does not need to be used. This allows the information processing apparatus 100 to appropriately use the external device 200 and to reduce an increase in the processing load or power consumption in the medium reading process.

The information processing apparatus 100 deactivates the external device 200 during times when a large amount of power is consumed, such as while a medium is being conveyed, while a medium is being imaged, or while an input image is being output. Thus, the information processing apparatus 100 prevents a momentary increase in power consumption and appropriately limits the power consumption of the apparatus.

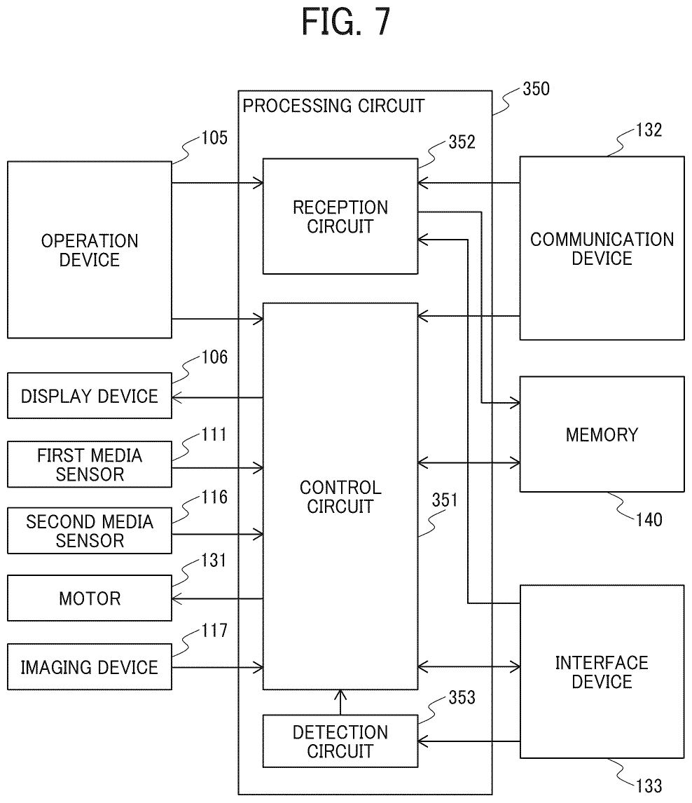

FIG. 7 is a schematic block diagram illustrating a configuration of a processing circuit 350 in the information processing apparatus 100 according to another embodiment.

The processing circuit 350 substitutes for the processing circuit 150 of the information processing apparatus 100 and performs the media reading process and the like instead of the processing circuit 150. The processing circuit 350 includes a control circuit 351, a reception circuit 352, and a detection circuit 353. These circuits may be implemented by, for example, independent integrated circuits, microprocessors, or firmware.

The control circuit 351, which corresponds to circuitry, functions in the same or substantially the same manner as the control unit 151. The control circuit 351 receives the operation signal from the operation device 105, the communication device 132, or the interface device 133, the first media signal from the first media sensor 111, and the second media signal from the second media sensor 116. The control circuit 351 reads the reception result of the permission setting by the reception circuit 352 from the memory 140 and receives the detection result of the external device 200 connected to the interface device 133 from the detection circuit 353. The control circuit 351 controls the motor 131 based on the acquired information and acquires an input image from the imaging device 117. The control circuit 351 outputs an inquiry window to the display device 106 or the communication device 132, and receives a correction instruction signal from the operation device 105, the communication device 132, or the interface device 133. The control circuit 351 corrects the input image based on the received correction instruction signal and outputs the corrected input image from the communication device 132 or the interface device 133.

The reception circuit 352, which corresponds to circuitry, functions in the same or substantially the same manner as the reception unit 152. The reception circuit 352 receives a permission setting for the mode change from the operation device 105, the communication device 132, or the interface device 133, and stores the reception result in the memory 140.
The detection circuit 353, which corresponds to circuitry, functions in the same or substantially the same manner as the detection unit 153. The detection circuit 353 receives the connected device signal from the interface device 133, detects the external device 200 connected to the interface device 133, and outputs the detection result to the control circuit 351.

As described above in detail, even when the processing circuit 350 is used, the information processing apparatus 100 appropriately controls communication with the external device 200 via the interface device 133 or power supply to the external device 200 via the interface device 133.

Embodiments of the present disclosure are not limited to the above-described embodiments. For example, the medium conveying path of the information processing apparatus 100 may be a so-called U-turn path, and the information processing apparatus may feed and convey media placed on the media tray sequentially from the top and eject the media to the ejection tray. In this configuration, the separation roller is located below the feed roller and faces the feed roller.

The information processing apparatus 100 may include an image forming device instead of or in addition to the imaging device 117. The image forming device employs, for example, an inkjet printing method or a laser printing method, is located at the position corresponding to the position of the imaging device 117, and forms an image (prints predetermined information) on a medium conveyed. The information processing apparatus 100 may be a so-called flatbed scanner, an overhead scanner, a facsimile, a copier, a multifunction peripheral printer, or the like that images a medium without conveying the medium. In this case, the imaging device is movable in the sub-scanning direction by a driving force from the motor. The information processing apparatus 100 may be a personal computer, a mobile phone, or the like including an imaging device that images a medium to generate an input image and an output device that displays or transmits the input image.

The control unit 151 may control the operation device 105 and/or the display device 106 based on the state of conveyance by the conveyor, the state of imaging by the imaging device 117, or the state of output by the communication device 132 in the same or substantially the same manner as controlling the operation device 201. In this case, the operation device 105 and/or the display device 106 are connected to the processing circuit 150 via the interface device 133. The control unit 151 changes whether to allow communication with the operation device 105 and/or the display device 106 via the interface device 133 or whether to allow supplying power to the operation device 105 and/or the display device 106 via the interface device 133 based on the state of conveyance by the conveyor, the state of imaging by the imaging device 117, or the state of output by the communication device 132. The control unit 151 prohibits communication with the operation device 105 and/or the display device 106 via the interface device 133 or stops supplying power to the operation device 105 and/or the display device 106 via the interface device 133 during the conveyance of a medium by the conveyor, during the imaging by the imaging device 117, or during the output by the communication device 132. Alternatively, the control unit 151 may permit communication with the operation device 105 and/or the display device 106 and supplying power to the operation device 105 and/or the display device 106 when the operation device 105 and/or the display device 106 are used. On the other hand, the control unit 151 may prohibit communication with the operation device 105 and/or the display device 106 or may stop supplying power to the operation device 105 and/or the display device 106 at other times.

According to an aspect of the present disclosure, an image reading method includes: imaging a medium by an imager to generate an input image; outputting the input image by an output device; and changing whether to allow communication with an external device via an interface connectable with the external device or whether to allow supplying power to the external device via the interface based on a state of imaging by the imager or a state of output by the output device.

According to another aspect of the present disclosure, a computer-readable, non-transitory medium stores a control program. The control program causes an image reading apparatus including an imager to image a medium to generate an input image, an output device to output the input image, and an interface connectable to an external device, to execute a process. The process includes changing whether to allow communication with the external device via the interface or whether to allow supplying power to the external device via the interface based on a state of imaging by the imager or a state of output by the output device.

The appropriate control of communication with an external device via an interface or power supply to the external device via the interface is required in a medium conveying apparatus and an image reading apparatus.

A medium conveying apparatus, an image reading apparatus, a medium conveying method, an image reading method, and a control program according to an embodiment of the present disclosure can appropriately control communication with an external device via an interface or power supply to the external device via the interface.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A medium conveying apparatus, comprising:
a conveyor to convey a medium;
an interface connectable to an external device; and
circuitry configured to change whether to allow communication with the external device via the interface or whether to allow supplying power to the external device via the interface based on a state of conveyance by the conveyor.

2. The medium conveying apparatus according to claim 1, wherein the interface is connectable to the external device that controls the medium conveying apparatus or acquires information from the medium conveying apparatus.

3. The medium conveying apparatus according to claim 1, wherein the circuitry is further configured to:
detect connection of the external device to the interface; and
change whether to allow communication with the external device via the interface or whether to allow supplying power to the external device via the interface further based on a state of connection of the external device to the interface.

4. The medium conveying apparatus according to claim 1, wherein the circuitry is further configured to receive a permission setting for changing whether to allow communication with the external device via the interface or whether to allow supplying power to the external device via the interface.

5. The medium conveying apparatus according to claim 1, wherein
the interface is connectable to a plurality of types of external devices including the external device, and
the circuitry changes whether to allow communication with the external device via the interface or whether to allow supplying power to the external device via the interface further based on a type of the external device connected to the interface among the plurality of types of external devices.

6. The medium conveying apparatus according to claim 1, wherein
the external device is an operation device that receives an operation, and
the circuitry prohibits communication with the external device via the interface or stops supplying power to the external device via the interface while the medium is being conveyed by the conveyor.

7. The medium conveying apparatus according to claim 1, wherein
the external device is a storage device that stores information, and
the circuitry prohibits communication with the external device via the interface or stops supplying power to the external device via the interface while the medium is being conveyed by the conveyor.

8. An image reading apparatus, comprising:
an imager to image a medium to generate an input image;
an output device to output the input image;
an interface connectable to an external device; and
circuitry configured to change whether to allow communication with the external device via the interface or whether to allow supplying power to the external device via the interface based on a state of imaging by the imager or a state of output by the output device.

9. The image reading apparatus according to claim 8, wherein the interface is connectable to the external device that controls the image reading apparatus or acquires information from the image reading apparatus.

10. The image reading apparatus according to claim 8, wherein the circuitry is further configured to:
detect connection of the external device to the interface; and
change whether to allow communication with the external device via the interface or whether to allow supplying power to the external device via the interface further based on a state of connection of the external device to the interface.

11. The image reading apparatus according to claim 8, wherein the circuitry is further configured to receive a permission setting for changing whether to allow communication with the external device via the interface or whether to allow supplying power to the external device via the interface.

12. The image reading apparatus according to claim 8, wherein
the interface is connectable to a plurality of types of external devices including the external device, and
the circuitry changes whether to allow communication with the external device via the interface or whether to allow supplying power to the external device via the interface further based on a type of the external device connected to the interface among the plurality of types of external devices.

13. The image reading apparatus according to claim 8, wherein
the external device is an operation device that receives an operation, and
the circuitry prohibits communication with the external device via the interface or stops supplying power to the external device via the interface while the medium is being imaged by the imager or while the input image is being output by the output device.

14. The image reading apparatus according to claim 8, wherein
the external device is a storage device that stores information, and
the circuitry prohibits communication with the external device via the interface or stops supplying power to the external device via the interface while the medium is being imaged by the imager.

15. A medium conveying method, comprising:
conveying a medium by a conveyor; and
changing whether to allow communication with an external device via an interface connectable with the external device or whether to allow supplying power to the external device via the interface based on a state of conveyance by the conveyor.

16. A computer-readable, non-transitory medium storing a control program, wherein the control program causes a medium conveying apparatus including a conveyor to convey a medium and an interface connectable with an external device, to execute a process, the process comprising:
changing whether to allow communication with the external device via the interface or whether to allow supplying power to the external device via the interface based on a state of conveyance by the conveyor.
